(19) United States
(12) Patent Application Publication
(10) Pub. No.: US 2005/0182706 A1
(43) Pub. Date: Aug. 18, 2005

(54) Auction bidding apparatus and method, and recording medium having auction bidding program recorded therein

(76) Inventors: Kensuke Shimizu, Yokohama (JP); Takeshi Imamura, Sagamihara (JP); Kenichiro Osaka, Tokyo (JP); Mitsuyoshi Watanabe, Matsudo (JP)

Correspondence Address: SWIDLER BERLIN LLP, 3000 K STREET, NW, BOX IP, WASHINGTON, DC, 20007, US

(21) Appl. No.: 10/919,258

(22) Filed: Aug. 17, 2004

(30) Foreign Application Priority Data
Feb. 16, 2004 (JP) 2004-038293

(51) Int. Cl. G06F 17/60

(52) U.S. Cl. 705/37

(57) ABSTRACT

In the so-called network auction through the internet, in order to support a user's bid and to mitigate a burden in knocking down a desired product, it is known that a reentry is carried out automatically within the maximum frame of bidding price set up by the user, even if the amount of a bid is updated. However, this conventional technology was limited to offering a bid only to single product. So, to solve such a problem, in the present invention, it is made to register the table for predetermined conditions to be matched to two or more products, and by referring to the above-mentioned table, automatically to offer a bid to other products which have a predetermined relation with a certain selected product according to the result of the justice of the closing bid.

### BACKGROUND OF THE INVENTION

1. Field of the Invention

The present invention generally relates to the field of automatically bidding for a product placed on show at an online auction conducted via a network using a computer. More particularly, the present invention relates to an auction bidding apparatus and method, and to a recording medium having an auction bidding program recorded therein.

Auction bidding by this invention can deal with any items including any products, goods, services, or any other items that can be traded.

2. Description of the Related Art

In so-called network auctions conducted through the Internet, typically, when a user browses or searches for auctioned products to find a desired product, the user sets up a certain bid amount and conducts predetermined operations to bid on this product. Such a typical bidding form places a heavy burden on the user because the user must always watch the bidding status of the product. In order to mitigate such a burden, in a known auto-bidding system, once a user sets up a maximum bid amount the user is willing to pay for a product when the user enters a first bid for the product, a reentry is automatically carried out up to the maximum bid amount even if the bid amount is updated.

Japanese Unexamined Patent Application Publication No. 2002-83170 discloses a system in which a user is notified of updating of a maximum bidding price via e-mail, including means for supporting a reentry.

However, the conventional technology described above is limited to offering a bid for only a single product.

In a case where a plurality of products of the same type as a desired product are for sale at an auction, the user must always watch the bidding status of the products of the same type, and must place bids for two or more products of the same type in order to increase the possibility of successfully closing the auction. In this case, the conventional technology described above can place a heavy burden on the user, and can cause two or more products of the same type to be won, which is unnecessary.

In another case where a user offers bids for a plurality of products that are used in combination, that is, one of the products is not necessary unless the other product is obtained, e.g., a video camera and a battery for use with the video camera, the user must first place a bid for the video camera, and must then place a bid for the battery after the user has successfully won the video camera. In this case, the user must perform both operations of watching the auction status as to whether or not the bidding for one product was successfully closed and placing a bid for another product, which is burdensome.

### SUMMARY OF THE INVENTION

Accordingly, it is an object of the present invention to provide a method for automatically bidding for a plurality of products at an online auction to mitigate the burden on a user.

The present invention provides a method for automatically bidding for a product placed on show at an online auction via a network using a computer, including the steps of tendering a bid for one of products by referring to a product group setting table in which a number of products are preliminarily registered and a predetermined relationship between those products is set up, judging whether the bidding for the tendered product was successfully closed or not, and determining whether the auction should be terminated or a following tender for the products registered beforehand as products related to the product should be made according to the judgment of the bidding.

In the present invention, in order to raise the possibility of winning the desired product, when bids are to be tendered for a plurality of auctioned products of the same type as a desired product, the plurality of products of the same type may be registered in the product group setting table, and the priority level may be set to the plurality of products registered in the product group setting table. In the determining step, if the bidding is successfully closed, the auction may be ended, and if not successfully closed, tendering for the next product that is set at a priority level one level higher than the desired product may be performed.

Furthermore, in the present invention, when bids are to be tendered for a plurality of products that are used in combination, the plurality of products may be registered in the product group setting table, and the subordinate product associated with the product for which the bidding was successfully closed may be set to the plurality of products registered in the product group setting table. In the determining step, if the bidding is not successfully closed, the auction may be ended, and if successfully closed, tendering for another product which is set as the subordinate product of the product for which the bidding was successfully closed may be performed.

### BRIEF DESCRIPTION OF THE DRAWINGS

FIG. 1 is a block diagram of an auction bidding mechanism according to the present invention;

FIG. 2 is an illustration of a product database;

FIG. 3 is a same-product-group setting table;

FIG. 4 is a related-product-group setting table;

FIG. 5 is a complex-product-group setting table;

FIG. 6 is a flowchart showing a setting and registration process for a product group setting table;

FIG. 7 is a flowchart showing a product group bidding program for bidding based on the same-product-group setting table;

FIG. 8 is a flowchart showing a product group bidding program for bidding based on the related-product-group setting table;

FIG. 9 is a flowchart showing a product group bidding program for bidding based on the complex-product-group setting table;

FIG. 10 is a display screen for product search and product registration in setting the product group setting table;

FIG. 11 is a display screen for setting the same-product-group setting table;

FIG. 12 is a display screen for setting the related-product-group setting table; and

FIG. 13 is a display screen for notifying the user of the bidding status during the auction based on the same-product-group setting table.

### DESCRIPTION OF THE PREFERRED EMBODIMENTS

An embodiment of the present invention will now be described with reference to the drawings.

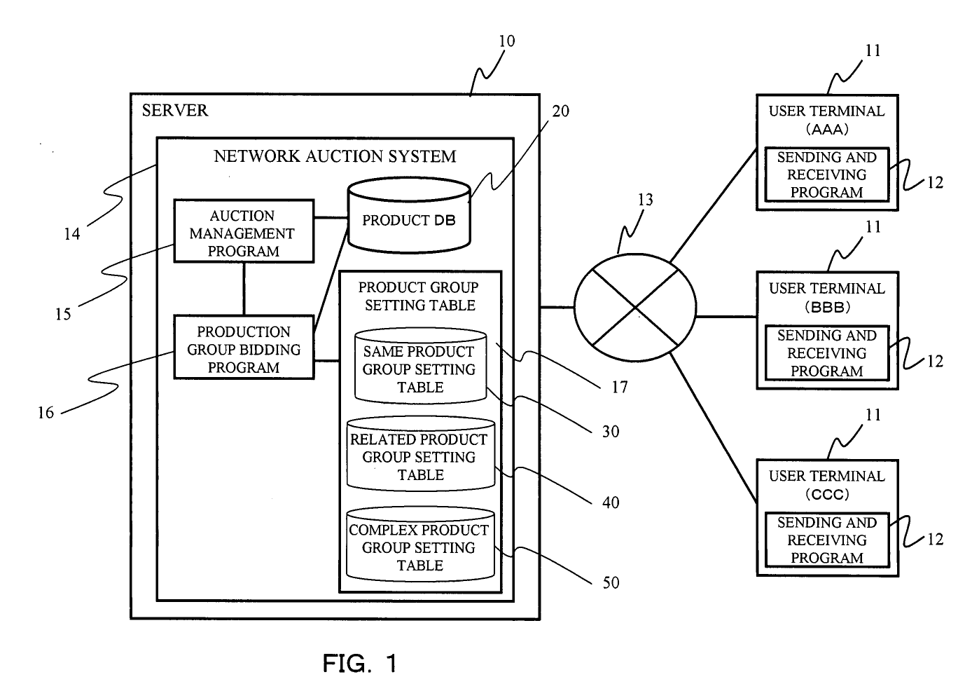

FIG. 1 shows an auction bidding mechanism according to an embodiment of the present invention. In FIG. 1, a server 10 and a user terminal 11 are connected via a network 13.

The user terminal 11 has a sending and receiving program 12. The sending and receiving program 12 may be a mailer program for sending and receiving e-mail, a browser program for displaying information received via a network, or the like. Although three user terminals are shown in FIG. 1, the number of user terminals is not limited to three.

The server 10 includes a network auction system 14 for conducting a network auction via a network. The network auction system 14 includes an auction management program 15 for implementing a network auction, a product group bidding program 16, a product database (DB) 20, and a product group setting table 17.

The auction management program 15 is a program that allows the server 10 to conduct a network auction, although the auction management program 15 is not described in detail herein because it does not constitute a feature of the present invention.

The product DB 20 is a database in which information on all products placed on show at the network auction is stored in association with various attribute information.

The product group bidding program 16, which constitutes the main feature of the present invention, is a program for suitably bidding for a plurality of products, as described below.

The product group setting table 17 is managed and used by the product group bidding program 16, and is a table in which a plurality of products to be bid on are stored in association with the priority or subordinate relation of the products. The product group setting table 17 includes a same-product-group setting table 30, a related-product-group setting table 40, and a complex-product-group setting table 50. Although the product group setting table 17 includes three sub-tables in FIG. 1, the product group setting table 17 does not include all three sub-tables and may include one to three sub-tables, if necessary.

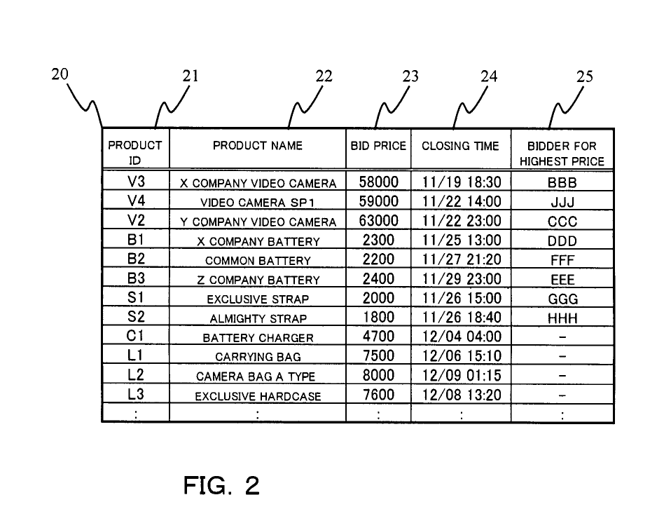

FIG. 2 shows an example of the product DB 20. In the product DB 20, a product ID 21, a product name 22, a bid price 23, a closing time 24, and a highest bidder 25 are stored in association with one another.

The product ID 21 is an identifier unique to each registered product. The product ID 21 is used to identify the product in the processing performed by the network auction system 14 in the server 10.

The product name 22 stores the name of products for sale at the network auction in the form of character sequences. The product name 22 is generally given by the seller of each product.

The bid price 23 stores an auction starting bid set by the seller of each product or the current highest bid during the auction.

The closing time 24 stores a closing time of the auction for each product for sale.

The highest bidder 25 stores the name of the bidder who placed the current highest bid during the auction or a bidder identifier like a user ID. Before the auction begins or if no one bids, no data is stored in the highest bidder 25.

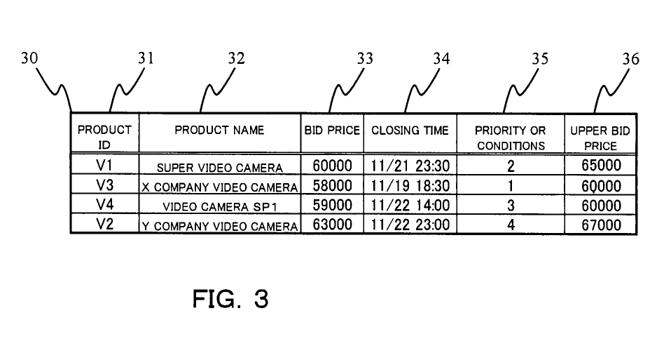

FIG. 3 shows an example of the same-product-group setting table 30. A user often desires to bid on a plurality of products of the same type as or a similar type to a desired product in order to raise the possibility of winning the desired product. In such cases, the plurality of products are registered in the same-product-group setting table 30 in association with the priority levels. The same-product-group setting table 30 includes a product ID 31, a product name 32, a bid price 33, a closing time 34, priority or conditions 35, and an upper bid price 36. Although the details of product registration in the same-product-group setting table 30 are described below, the user searches for the desired product in the auctioned products, i.e., the products registered in the product DB 20, to select products, and conducts predetermined operations for registering the products in the same-product-group setting table 30.

The product ID 31 stores an identifier unique to each product. The product name 32 stores the name of the registered products. The bid price 33 stores an auction starting bid set by the seller of each product or the current highest bid during the auction. The closing time 34 stores a closing time of the auction for each product. The product ID 31, the product name 32, the bid price 33, and the closing time 34 stored in the same-product-group setting table 30 corresponds to those registered in the product DB 20. Thus, when the user registers a product in the same-product-group setting table 30, the data of the product, which is stored in the product DB 20, is copied.

The priority or conditions 35 store bidding priority or conditions for the registered products, which are set by the user at registration time. In the example shown in FIG. 3, the priority is set. In this case, in a bidding process based on the same-product-group setting table 30, “X Company Video Camera,” which is set to “1” in the priority or conditions 35, is bid on first. If the bidding for the “X Company Video Camera” fails, then, “Super Video Camera,” which is set to “2” in the priority or conditions 35, is bid on. Accordingly, if the bidding for a product is successfully closed, the auction for this product is terminated, whereas, if the bidding for a product fails, a product having the next priority in the priority or conditions 35 is bid on.

Although not shown in FIG. 3, bidding priority conditions may be set in the priority or conditions 35. For example, if the “bid price” is set in the priority or conditions 35, a product having a lower value in the bid price 33 is bid on with priority. In the example shown in FIG. 3, the “X Company Video Camera” having “58000” in the bid price 33 is bid on first, and the “Video Camera SP1” having “59000” is then bid on if the bidding for the “X Company Video Camera” has failed. For example, if the “closing time” is set in the priority or conditions 35, a product having the earliest auction closing time is bid on with priority. Thus, the “X Company Video Camera” having “11/19 18:30” in the closing time 34 is bid on first, and the “Super Video Camera” having “11/21 23:30” in the closing time 34 is then bid on if the bidding for the “X Company Video Camera” has failed.

The upper bid price 36 stores the bid amount up to which the user is to pay for the product. While a method for bidding for a plurality of products at a network auction constitutes a feature of the present invention, an auction procedure for a single product is the same as a known network auction procedure. That is, as previously described, bids are automatically entered up to a given maximum amount even if another user outbids. The maximum amount is set in the upper bid price 36. While the upper bid price 36 is set for each product registered in the table shown in FIG. 3, taking the market prices, etc., into consideration, a common upper bid price 36 may be set for the four products registered in the table.

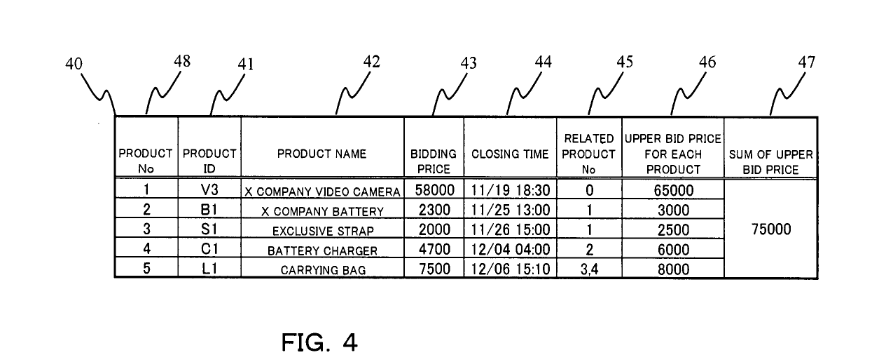

FIG. 4 shows an example of the related-product-group setting table 40. A user often desires to win auctions for a combination of a desired product and a product for use with the desired product, e.g., a video camera and its auxiliary product, such as a battery. In this case, the battery is not necessary unless the video camera is won and obtained.

The user is therefore to place a bid for the battery after the bidding for the video camera has been successfully closed in order to avoid the inconvenience of winning the battery although the bidding for the video camera failed. In the conventional technology, however, such an operation places a heavy burden on the user.

The related-product-group setting table 40 is a table for registering a plurality of products having such a subordinate relation in association with their related products so as to, after winning a certain product, place a bid for other products related to this product. The related-product-group setting table 40 includes a product number 48, a product ID 41, a product name 42, a bidding price 43, a closing time 44, a related product number 45, an upper bid price for each product 46, and a sum of upper bid prices 47. The registration in the related-product-group setting table 40 is carried out by basically the same operations as in the registration in the same-product-group setting table 30.

The product number 48 is uniquely assigned to a product registered in the related-product-group setting table 40, and is used for setting the related product number 45 described below. The product ID 41, the product name 42, the bidding price 43, and the closing time 44 are similar to the product ID 31, the product name 32, the bid price 33, and the closing time 34 in the same-product-group setting table 30, respectively.

The related product number 45 stores the product number of a product related to a given product that is to be won before placing a bid for the related product. That is, the product number 48 of the given product is stored in the related product number 45 of the product related to this product. In FIG. 4, “X Company Video Camera” is set to “0” in the related product number 45, indicating that the “X Company Video Camera” is a product desired by the user. In this case, the user desires to, after winning the “X Company Video Camera”, win an accessory for the “X Company Video Camera”. In the example shown in FIG. 4, “X Company Battery” is set to “1” in the related product number 45, indicating that the “X Company Battery” is bid on under the conditions that the bidding for the “X Company Video Camera” having “1” in the product number 48 was successfully closed. In this example, “Carrying Bag” is set to “3, 4” in the related product number 45, indicating that a bid for the “Carrying Bag” is placed when the bidding for both “Exclusive Strap” having “3” in the product number 48 and “Battery Charger” having “4” in the product number 48 was successfully closed.

The upper bid price for each product 46 is similar to the upper bid price 36 in the same-product-group setting table 30.

The sum of upper bid prices 47 stores an upper limit on the sum of the bid prices for the plurality products registered in the related-product-group setting table 40. In other words, the user's budget for the plurality of products to be obtained is set in this column. In the example shown in FIG. 4, the sum of upper bid prices 47 is “75000”. For example, if the sum of the closing bids for three of the products registered in the related-product-group setting table 40 is 70000 yen, when the current bidding price 43 for a fourth product is 5500 yen, the sum of the bid prices for the four products is over 75000 yen. In the bidding process based on the related-product-group setting table 40, therefore, the auction is terminated without placing a bid for the fourth product.

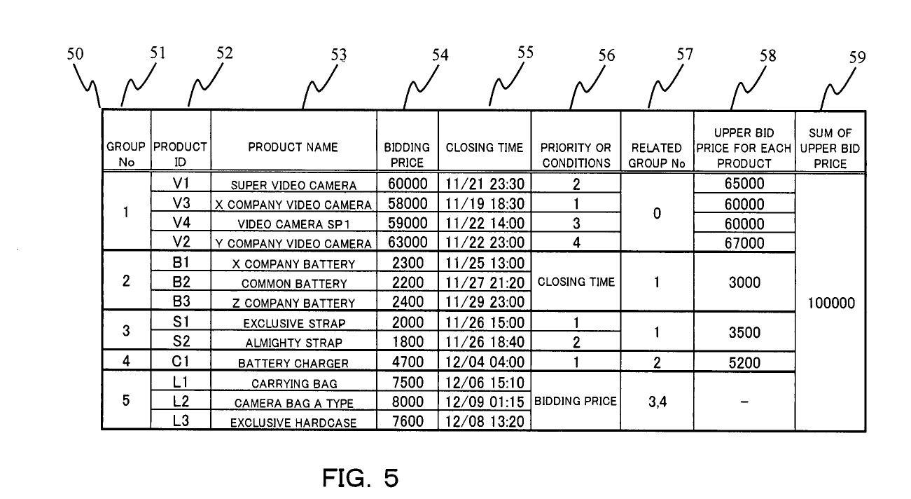

FIG. 5 shows an example of the complex-product-group setting table 50. The complex-product-group setting table 50 has a combination of the functions of the same-product-group setting table 30 and the related-product-group setting table 40. That is, one product in the related-product-group setting table 40 is replaced with one group in the same-product-group setting table 30. For example, four products included in group No. “1”, i.e., “Super Video Camera”, “X Company Video Camera”, “Video Camera SP1”, and “Y Company Video Camera”, are processed in the same way as in the same-product-group setting table 30. When any one of the products included in the group No. “1” was successfully won, a bidding process for the product group of groups No. “2” and No. “3” is performed. The complex-product-group setting table 50 includes a group number 51, a product ID 52, a product name 53, a bidding price 54, a closing time 55, priority or conditions 56, a related group number 57, an upper bid price for each product 58, and a sum of upper bid prices 59.

The group number 51 is uniquely assigned to a group of products of the same or similar type. The group number 51 is used for setting the related group number 57 described below.

The product ID 52, the product name 53, the bidding price 54, and the closing time 55 are similar to the product ID 31, the product name 32, the bid price 33, and the closing time 34 in the same-product-group setting table 30, respectively.

The priority or conditions 56 are similar to the priority or conditions 35 in the same-product-group setting table 30, except that the priority or conditions 56 are set for each group.

The related group number 57 is similar to the related product number 45 in the related-product-group setting table 40, except that the related group number 57 is set not for each product but for each product group identified by the group number 51.

The upper bid price for each product 58 is similar to the upper bid price 36 in the same-product-group setting table 30. The sum of upper bid prices 59 is similar to the sum of upper bid prices 47 in the related-product-group setting table 40.

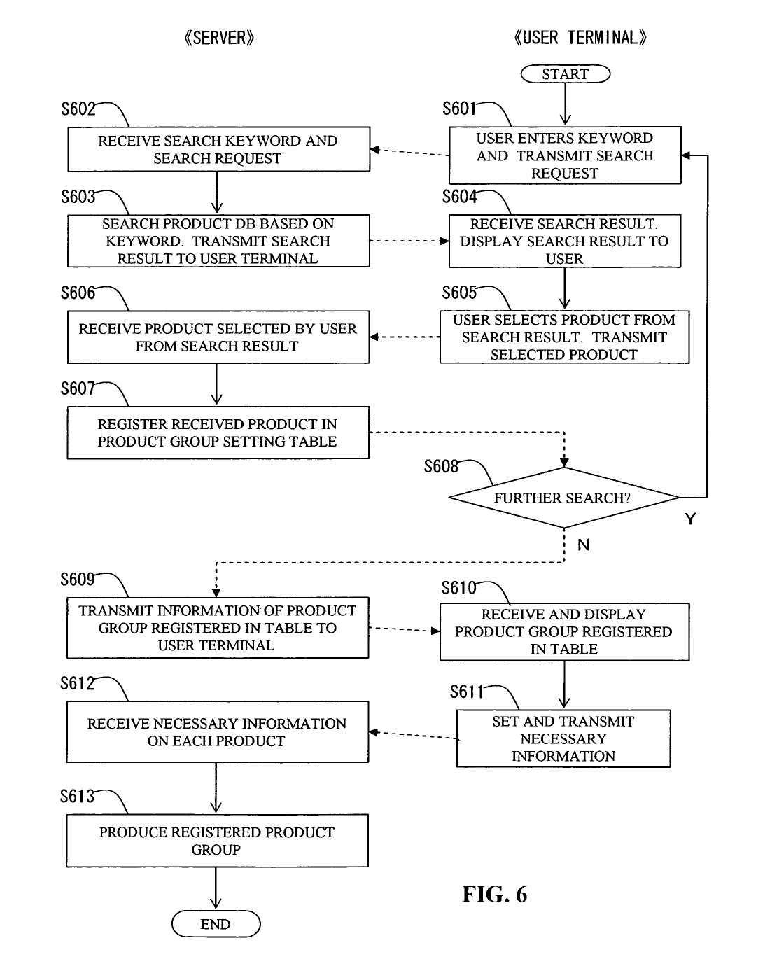

The product group bidding program 16 is a program for implementing processes according to the present invention, namely, a process for setting a product group in a table, and a process for placing bids based on the set table. Example operations of the product group bidding program 16 will now be described with reference to the flowcharts shown in FIGS. 6 to 9.

FIG. 6 is a flowchart showing a process for selecting a desired product from multiple products for sale at a network auction and registering the product in the product group setting table 17.

In step S601, the user enters a keyword for searching for a product name on the user terminal 11 to determine whether or not the desired product is for sale on the network auction, and transmits the keyword and a search request to the server 10.

In step S602, the server 10 receives the search keyword and the search request from the user terminal 11.

In step S603, the server 10 searches the product DB 20 based on the received keyword, and transmits a search result, that is, product information including the keyword, to the user terminal 11 to present the result to the user.

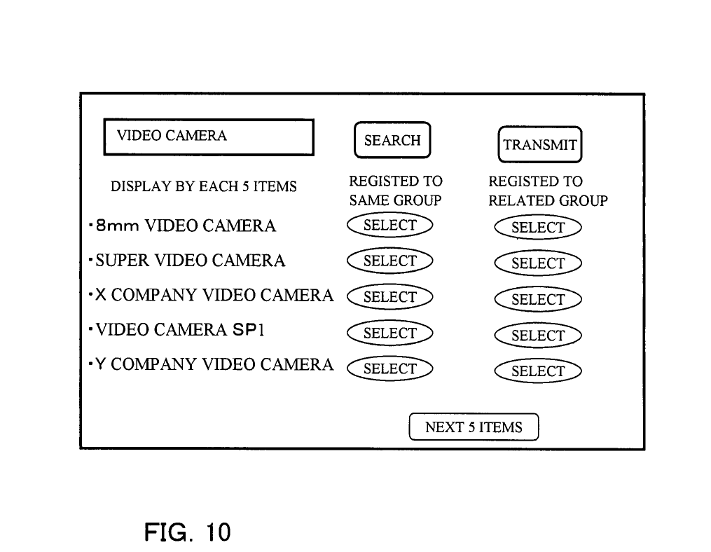

In step S604, the user terminal 11 receives the search result, or the product information, and displays it to the user according to the sending and receiving program 12. An example display screen is shown in FIG. 10. In FIG. 10, a search keyword is entered in a field in the upper left portion of the screen, and a “video camera” is entered in this field. By clicking a search button, the entered keyword is transmitted to the server 10 as a transmission request (step S601). When a search result is received from the server 10, the details of the search result are shown on the screen. In this example, “8 mm Video Camera”, “Super Video Camera”, “X Company Video Camera”, “Video Camera SP1”, and “Y Company Video Camera” are shown as search results.

In step S605, in response to a user selection of a product to be registered as a product group from the search results, the user terminal 11 transmits the information on the selected product to the server 10. In the example shown in FIG. 10, a “SELECT” button of a product to be registered as a product group is clicked, and a “TRANSMIT” button in the upper right portion of the screen is then clicked, thereby performing the processing of step S605.

In step S606, the server 10 receives the information on the product selected in step S605.

In step S607, the server 10 registers the information on the product received in step S606, which is registered in the product DB 20, in the product group setting table 17. Which of the same-product-group setting table 30, the related-product-group setting table 40, or the complex-product-group setting table 50 the information is to be registered in is determined based on the operation of the user in step S605. In the example shown in FIG. 10, registration in the complex-product-group setting table 50 is not presumed, but can obviously be achieved in the same manner as that in registration in the other tables.

In step S608, it is determined whether or not the user desires a further keyword-based product search. If the user desires a further search, the process returns to step S601. If the user does not desire a further search, the process proceeds to step S609.

In step S609, the server 10 transmits the information on the product registered in the product group setting table 17 to the user terminal 11 to prompt the user to set further necessary information.

In step S610, the user terminal 11 receives the product information transmitted from the server 10, and shows the content. In step S611, the user sets necessary information on a displayed product, and the user terminal 11 transmits the necessary information to the server 10.

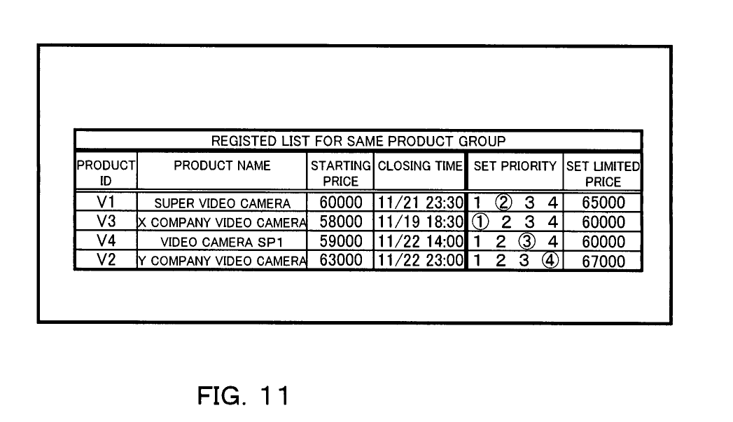

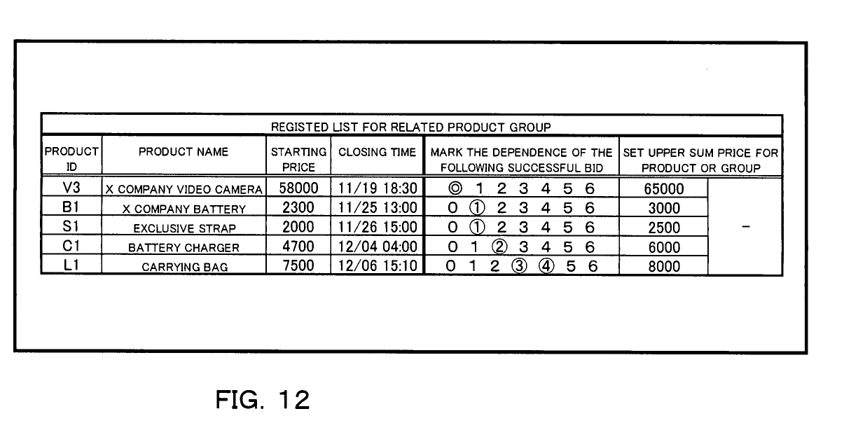

Example display screens in the processing of steps S610 and S611 are shown in FIGS. 11 and 12.

FIG. 11 is a screen for setting necessary information on the products registered in the same-product-group setting table 30. The user sets a “set priority” column and a “set limited price” column for the product information that is transmitted from the server 10 and that is shown on the user terminal 11. The “set priority” column is used for setting the priority or conditions 35 in the same-product-group setting table 30, and is used to determine the priority of bidding for the plurality of registered products. The “set limited price” column is used for setting the upper bid price 36 in the same-product-group setting table 30. The set information is transmitted from the user terminal 11 to the server 10.

FIG. 12 is a screen for setting necessary information on the products registered in the related-product-group setting table 40. The user sets a “mark the dependence of the following successful bid” column and a “set upper sum price for product or group” column for the product information that is transmitted from the server 10 and that is shown on the user terminal 11. The former column is used for setting the related product number 45 in the related-product-group setting table 40, and the latter column is used for setting the upper bid price for each product 46 and the sum of upper bid prices 47 in the related-product-group setting table 40. The set information is transmitted from the user terminal 11 to the server 10.

In step S612, the server 10 registers the necessary information on the products received from the user terminal 11 in a predetermined product group setting table. Specifically, as described above, necessary information on the received products is registered in the priority or conditions 35 and the upper bid price 36 in the same-product-group setting table 30, or the related-product-number 45, the upper bid price for each product 46, and the sum of upper bid prices 47 in the related-product-group setting table 40.

In step S613, the server 10 completes registration in the product group setting table 17. The processing up to step S612 is performed to register each item in the product group setting table 17, and, in step S613, a final table that helps the user place a bid on the auction is produced as a result of registration.

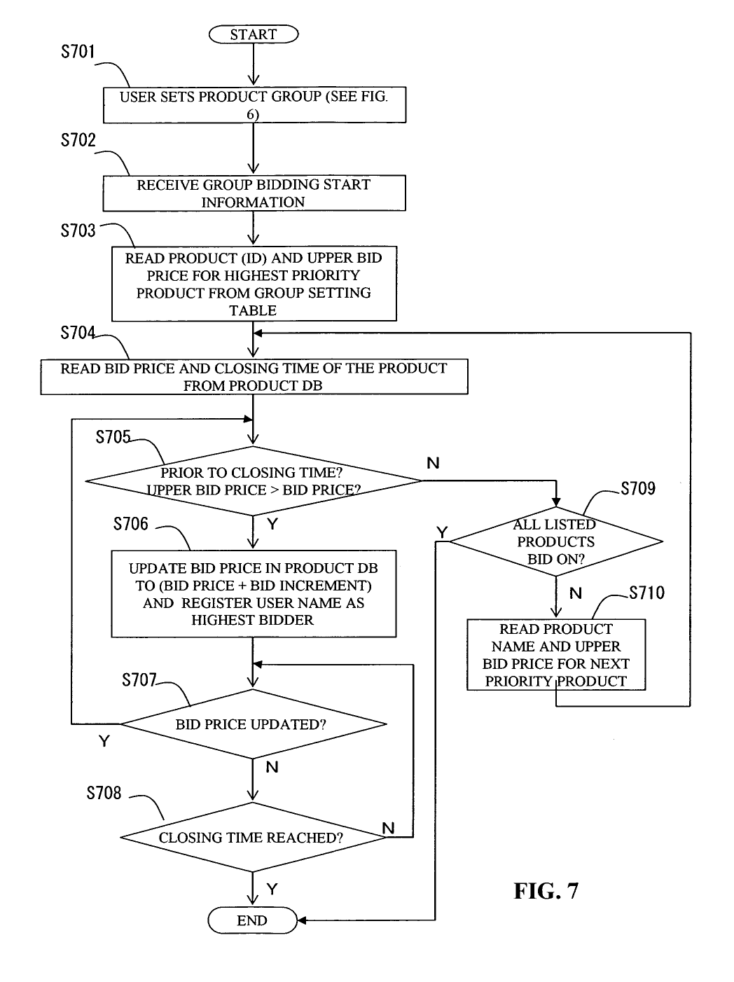

FIG. 7 is a flowchart showing a bidding process for a plurality of products based on the same-product-group setting table 30. In this flowchart, it is presumed that the user terminal 11 having a user name “AAA” places a bid.

In step S701, predetermined information is received from the user terminal 11, and the same-product-group setting table 30 is set. The processing of step S701 corresponds to the process shown in the flowchart of FIG. 6.

In step S702, group bidding start information is received from the user terminal 11. The group bidding start information is information sent from the user terminal 11 to the server 10 when the user operates the user terminal 11 to start network auction bidding based on the set same-product-group setting table 30.

In step S703, the product ID 31 and the upper bid price 36 for the product set to “1” in the priority or conditions 35 are read from the same-product-group setting table 30. This product is a product that the user wishes to most win, and is therefore a product to be bid on first. In the example shown in FIG. 3, the product ID 31, i.e., “V3”, and the upper bid price 36, i.e., “60000”, are read.

In step S704, in order to obtain the current auction status of this product, the product ID 21 in the product DB 20 is searched based on the product ID 31 read in step S703 to read the bid price 23 and the closing time 24 of the product. In the illustrated example, the product ID 21 in the product DB 20 is searched based on the product ID, i.e., “V3”, to retrieve the product name 22, i.e., “X Company Video Camera”. Thus, it is determined that the current bid price 23 is “58000” and the closing time 24 is “11/19 18:30”.

In step S705, it is determined whether or not the current time is prior to the closing time 24 read in step S704 and whether or not the upper bid price 36 read in step S703 is higher than the bid price 23 read in step S704 or the bid price 23 that is updated by another user in step S707 described below. If the current time is prior to the closing time 24 and the upper bid price 36 is higher than the bid price 23, the process proceeds to step S706. If the current time has passed the closing time 24 or if the bid price 23 is higher, the process proceeds to step S709. In the illustrated example, it is presumed that the current time is prior to the closing time 24, and the upper bid price 36, i.e., “60000”, is higher than the bid price 23, i.e., “58000”. Then, the process proceeds to step S706.

In step S706, the bid price 23 for the product stored in the product DB 20 is updated to the amount in which a bid increment is added to the current bid price, and the name of the user who updates the bid amount, i.e., “AAA”, is registered in the highest bidder 25. The term bid increment means the minimum unit amount a product increases in price after each new bid, and a seller of an auctioned product may set the increment for each product for sale. In step S706, this user becomes the bidder of the current highest price. In the illustrated example, the bid price 23 for the “X Company Video Camera” in the product DB 20 is “58000”, and the highest bidder 25 is “BBB”. As a result of the processing of step S706, the bid price 23 is updated to “59000” and the highest bidder 25 is updated to “AAA”, where the bid increment is set to 1000 yen.

In step S707, it is determined whether or not the current bid price 23 has been updated by another user. If the current bid price 23 has not been updated, the user “AAA” is still the highest bidder. Then, the process proceeds to step S708. If the current bid price 23 has been updated, the process returns to step S705, in which it is determined whether or not a higher price is bid to increase the bid price.

In step S708, the network auction continues over time, and it is determined whether or not the closing time 24 for the product is reached. If it is determined that the closing time 24 is not reached, the network auction for this product continues, and the process returns to step S707, in which it is determined whether or not the current bid price 23 has been updated by another user. If it is determined that the closing time 24 is reached, the auction is closed with the user “AAA” being the highest bidder 25, meaning that this user has successfully won the product. Then, the process ends.

In step S709, since it is determined that the bidding for the desired product failed in step S705, it is determined whether or not any product to be bid on still remains by referring to the same-product-group setting table 30. If it is determined that any product to be bid on still remains, the process proceeds to step S710.

In step S710, in order to place a bid for the next candidate product, the information on the product that is set to the second highest priority in the priority or conditions 35 is read from the same-product-group setting table 30. In the example shown in FIG. 3, if the bidding for the “X Company Video Camera” failed, the information on the “Super Video Camera” that is set to “2” in the priority or conditions 35 is read.

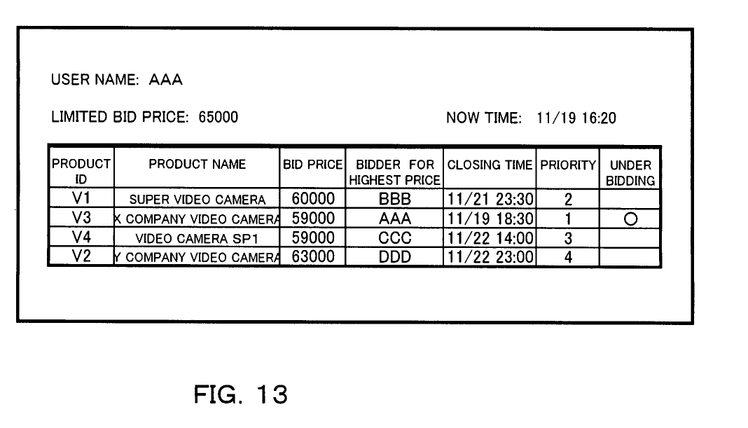

FIG. 13 shows an example screen displayed on the user terminal 11 for notifying the user of the auction status in the bidding process based on the same-product-group setting table 30 described above. On the display screen, the information set in the same-product-group setting table 30 shown in FIG. 3 and the information of the auction status of the listed products, which is retrieved from the product DB 20, are displayed in the viewable style. In the upper portion of the screen, the user name “AAA” is shown, and the upper bid price 36 for the product group under the bidding is set to “65000”. The current bid price for each product, which is retrieved from the bid price 23 in the product DB 20, is also shown. For example, the current bid price for the “X Company Video Camera” is “59000”, and the highest bidder is “AAA”. A circle in an “under bidding” column indicates that the user “AAA” is currently bidding on the “X Company Video Camera” in this product group.

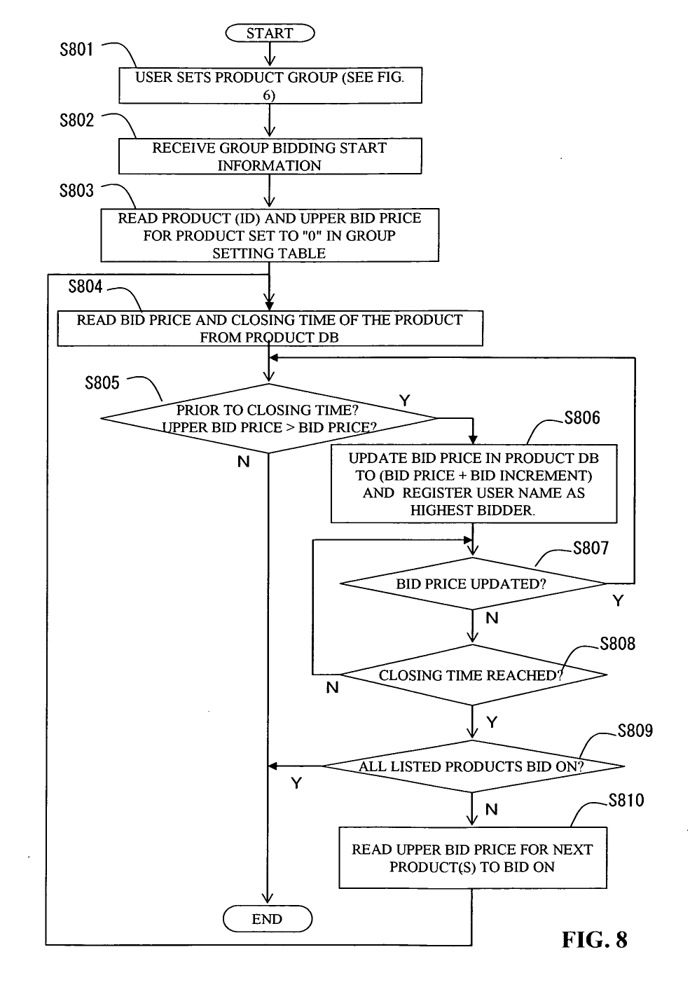

FIG. 8 is a flowchart showing a bidding process for a plurality of products based on the related-product-group setting table 40. In this flowchart, it is presumed that the user terminal 11 having a user “AAA” places a bid.

In step S801, predetermined information is received from the user terminal 11, and the related-product-group setting table 40 is set. The processing of step S801 corresponds to the process shown in the flowchart of FIG. 6.

In step S802, group bidding start information is received from the user terminal 11. The group bidding start information is information sent from the user terminal 11 to the server 10 when the user operates the user terminal 11 to start network auction bidding based on the set related-product-group setting table 40.

In step S803, at least the product ID 41 and the upper bid price for each product 46 for the product set to “0” in the related product number 45 are read from the related-product-group setting table 40. This product is a product that the user wishes to first win, and is therefore a product to be bid on first. In the example shown in FIG. 4, the product ID 41, i.e., “V3”, and the upper bid price for each product 46, i.e., “65000”, of the “X Company Video Camera” set to “0” in the related-product-number 45 are read.

In step S804, in order to obtain the auction status of this product, the product ID 21 in the product DB 20 is searched based on the product ID 41 read in step S803 to read the bid price 23 and the closing time 24 of the product. In the illustrated example, the product ID 21 in the product DB 20 is searched based on the product ID, i.e., “V3”, to retrieve the product name 22, i.e., “X Company Video Camera”. Thus, it is determined that the current bid price 23 is “58000” and the closing time 24 is “11/19 18:30”.

In step S805, it is determined whether or not the current time is prior to the closing time 24 read in step S804 and whether or not the upper bid price for each product 46 read in step S803 is higher than the bid price 23 read in step S804 or the bid price 23 that is updated by another user in step S807 described below. If the current time is prior to the closing time 24 and the upper bid price for each product 46 is higher than the bid price 23, the process proceeds to step S806. If the current time has passed the closing time 24 or if the bid price 23 is higher, it is determined that the user failed the bidding for this product, and the process ends. In the illustrated example, it is presumed that the current time is prior to the closing time 24, and the upper bid price for each product 46, i.e., “65000”, is higher than the bid price 23, i.e., “58000”. Then, the process proceeds to step S806.

In step S806, the bid price 23 for the product stored in the product DB 20 is updated to the amount in which a bid increment is added to the current bid price, and the name of the user who updates the bid amount, i.e., “AAA”, is registered in the highest bidder 25. In step S806, this user becomes the bidder of the current highest price. In the illustrated example, the bid price 23 for the “X Company Video Camera” in the product DB 20 is “58000”, and the highest bidder 25 is “BBB”. As a result of the processing of step S806, the bid price 23 is updated to “59000” and the highest bidder 25 is updated to “AAA”, where the bid increment is set to 1000 yen.

In step S807, it is determined whether or not the current bid price 23 has been updated by another user. If the current bid price 23 has not been updated, the user “AAA” is still the highest bidder. Then, the process proceeds to step S808. If the current bid price 23 has been updated, the process returns to step S805, in which it is determined whether or not a higher price is bid to increase the bid price.

In step S808, the network auction continues over time, and it is determined whether or not the closing time 24 for the product is reached. If it is determined that the closing time 24 is not reached, the network auction for this product continues, and the process returns to step S807, in which it is determined whether or not the current bid price 23 has been updated by another user. If it is determined that the closing time 24 is reached, the auction is closed with the user “AAA” being the highest bidder 25, meaning that this user has successfully won the product. Then, the process proceeds to step S809 in order to determine whether or not there is any product to be bid on in association with winning the product.

In step S809, it is determined that the bidding for the desired product was successfully closed in step S808, and it is determined whether or not there is any product to be bid on under the conditions of successfully closing the bidding for the desired product by referring to the related-product-group setting table 40. If it is determined that there is any product to be bid on, the process proceeds to step S810. If there is no product to be bid on, the process ends.

In step S810, in order to search for the product to be bid on under the conditions of successfully closing the bidding for the desired product, the information on the product whose related product number 45 has the value of the product number 48 of the desired product is read. In the example shown in FIG. 4, the product number 48 of the won product, i.e., “X Company Video Camera”, is “1”, and the products set to “1” in the related product number 45, i.e., “X Company Battery” and “Exclusive Strap”, are found. Then, the information on the “X Company Battery” and the “Exclusive Strap” is read. Then, the process returns to step S804 to bid on these products.

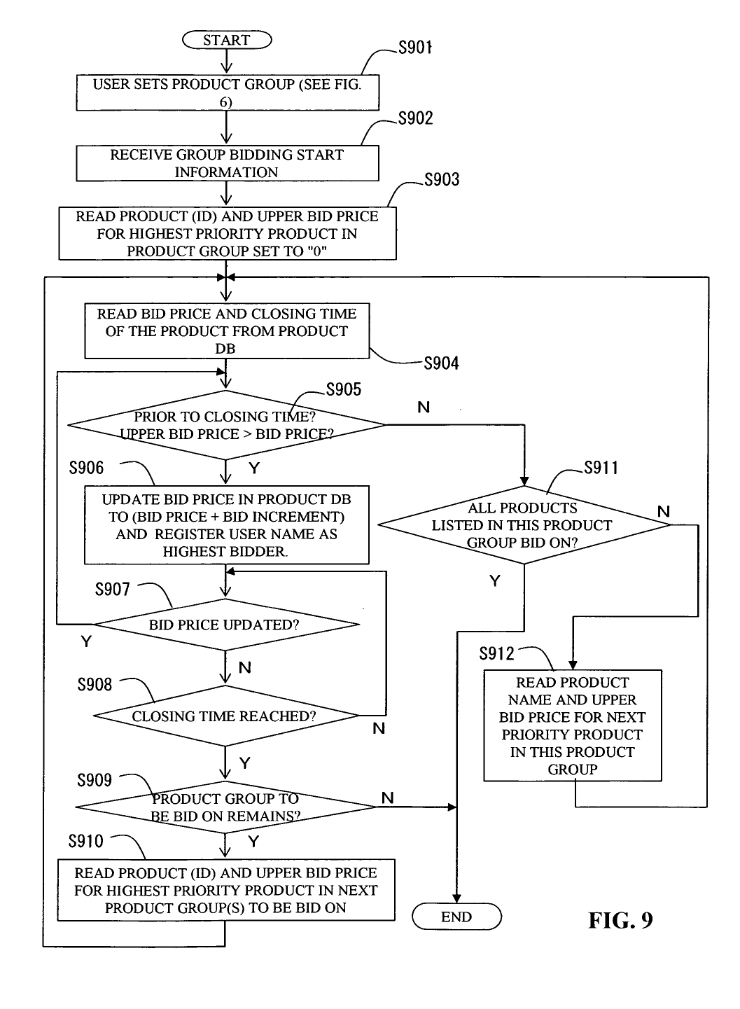

FIG. 9 is a flowchart showing a bidding process for a plurality of products based on the complex-product-group setting table 50. In this flowchart, it is presumed that the user terminal 11 having a user “AAA” places a bid.

In step S901, predetermined information is received from the user terminal 11, and the complex-product-group setting table 50 is set. The processing of step S901 corresponds to the process shown in the flowchart of FIG. 6.

In step S902, group bidding start information is received from the user terminal 11. The group bidding start information is information sent from the user terminal 11 to the server 10 when the user operates the user terminal 11 to start network auction bidding based on the set complex-product-group setting table 50.

In step S903, at least the product ID 52 and the upper bid price for each product 58 for the product having the highest priority in the priority or conditions 56 in the product group set to “0” in the related product number 57 are read from the complex-product-group setting table 50. This product is a product that the user wishes to first win, and is therefore a product to be bid on first. In the example shown in FIG. 5, the product ID 52, i.e., “V3”, and the upper bid price for each product 58, i.e., “60000”, of the “X Company Video Camera” in the product group set to “0” in the related product number 57, which is set to “1” in the priority or conditions 56, are read.

In step S904, in order to obtain the auction status of this product, the product ID 21 in the product DB 20 is searched based on the product ID 52 read in step S903 to read the bid price 23 and the closing time 24 of the product. In the illustrated example, the product ID 21 in the product DB 20 is searched based on the product ID, i.e., “V3”, to retrieve the product name 22, i.e., “X Company Video Camera”. Thus, it is determined that the current bid price 23 is “58000” and the closing time 24 is “11/19 18:30”.

In step S905, it is determined whether or not the current time is prior to the closing time 24 read in step S904 and whether or not the upper bid price for each product 58 read in step S903 is higher than the bid price 23 read in step S904 or the bid price 23 that is updated by another user in step S907 described below. If the current time is prior to the closing time 24 and the upper bid price for each product 58 is higher than the bid price 23, the process proceeds to step S906. If the current time has passed the closing time 24 or if the bid price 23 is higher, it is determined that the user failed the bidding for this product, and the process proceeds to step S911. In the illustrated example, it is presumed that the current time is prior to the closing time 24, and the upper bid price for each product 58, i.e., “60000”, is higher than the bid price 23, i.e., “58000”. Then, the process proceeds to step S906.

In step S906, the bid price 23 for the product stored in the product DB 20 is updated to the amount in which a bid increment is added to the current bid price, and the name of the user who updates the bid amount, i.e., “AAA”, is registered in the highest bidder 25. In step S906, this user becomes the bidder of the current highest price. In the illustrated example, the bid price 23 for the “X Company Video Camera” in the product DB 20 is “58000”, and the highest bidder 25 is “BBB”. As a result of the processing of step S906, the bid price 23 is updated to “58000” and the highest bidder 25 is updated to “AAA”, where the bid increment is set to 1000 yen.

In step S907, it is determined whether or not the current bid price 23 has been updated by another user. If the current bid price 23 has not been updated, the user “AAA” is still the highest bidder. Then, the process proceeds to step S908. If the current bid price 23 has been updated, the process returns to step S905, in which it is determined whether or not a higher price is bid to increase the bid price.

In step S908, the network auction continues over time, and it is determined whether or not the closing time 24 for the product is reached. If it is determined that the closing time 24 is not reached, the network auction for this product continues, and the process return to step S907, in which it is determined whether or not the current bid price 23 has been updated by another user. If it is determined that the closing time 24 is reached, the auction is closed with the user “AAA” being the highest bidder 25, meaning that this user has successfully won the product. Then, the process proceeds to step S909.

In step S909, it is determined whether or not there is any product to be bid on in association with winning the product. That is, it is determined whether or not there is any product group to be bid on by referring to the complex-product-group setting table 50. If it is determined that there is any product group to be bid on, the process proceeds to step S910 in order to continuously conduct an auction for another product. If there is no product group to be bid on, the process ends;

In step S910, in order to search for the product to be bid on under the conditions of successfully closing the bidding for the desired product, the product group whose related group number 57 has the value of the product number 51 of the product group to which the desired product belongs is retrieved from the complex-product-group setting table 50, and the information on the product having the highest priority in the priority or conditions 56 is read from the retrieved product group. In the example shown in FIG. 5, the product number 51 of the product group to which the won product, i.e., “X Company Video Camera”, belongs is “1”, and the product groups set to “1” in the related product number 57, i.e., the product groups having “2” and “3” in the group number 51, are found. The priority or conditions 56 of the product group set to “2” in the group number 51 are the “closing time”, and it is therefore determined that the “X Company Battery” set to the earliest time, i.e., “11/25 13:00”, in the closing time 55 is the next product to be bid on. Further referring to the priority or conditions 56 of the product group set to “3” in the group number 51, it is determined that the “Exclusive Strap” having the highest priority in this product group is also the next product to be bid on. In this manner, it is determined that the “X Company Battery” and the “Exclusive Strap” are the next products to be bid on. Then, the information on these products is read from the complex-product-group setting table 50, and the process returns to step S904 to bid on these products.

In step S911, since it is determined that the bidding for the desired product failed in step S905, it is determined whether or not any product to be bid on still remains in the product group to which the desired product belongs by referring to the complex-product-group setting table 50. If it is determined that any product to be bid on still remains, the process proceeds to step S912. If no product to be bid on remains, the process ends.

In step S912, in order to place a bid for the next candidate product, the information on the product that is set to the second highest priority in the priority or conditions 56 in the product group to which the desired product belongs is read from the complex-product-group setting table 50, and the process returns to step S904 to bid on this product. In the example shown in FIG. 5, if the bidding for the “X Company Video Camera” failed, the information on the “Super Video Camera” is read. Then, the process returns to step S904.

Although not shown, the server 10 and the user terminal 11 are computers controlled by a central processing unit (CPU). The CPU is connected to a random access memory (RAM), a hard disk device (HDD), a graphic processor, an input interface, a communication interface, and so on via a bus.

The RAM temporarily stores an operating system (OS) program to be executed by the CPU and at least a portion of other programs. The RAM also stores data necessary for processing of the CPU. The HDD stores the OS or other programs and data.

The graphic processor is connected to a monitor. The graphic processor causes an input screen to be displayed on the monitor in response to an instruction from the CPU. The input interface is connected to a keyboard, a mouse, and so on. The input interface transmits a signal sent from the keyboard, the mouse, etc., to the CPU via the bus.

The communication interface is connected to the network 13. The communication interface exchanges data between the server 10 and the user terminal 11 over the network 13.

The auction management program 15 and the product group bidding program 16 according to the illustrated embodiment of the present invention may be executed on the computer, thereby functioning the computer as an auction apparatus.

In this case, the functions of the computer may be described in a program recorded on a computer-readable recording medium. This program may be executed by the computer, thereby realizing the processes described above on the computer. The computer-readable recording medium may be implemented by a magnetic recording device, a semiconductor memory, or the like. In order to distribute the program on the market, the program may be stored in portable recording media, such as a compact disk read-only memory (CD-ROM) and a flexible disk, or may be stored in a storage device of a computer connected via a network, which is transferred to another computer over the network. In order to execute the program on a computer, the program may be stored in an internal hard disk device of the computer, and may be loaded into a main memory.

The present invention is not limited to the illustrated embodiment, and a variety of modifications or variations may be made without departing from the scope of the invention.

1. A method for automatically bidding for an item placed on show at an online auction via a network using a computer, comprising the steps of:
tendering a bit for one of products by referring to a product group setting table in which a number of products are preliminarily registered and a predetermined relationship between those products is set up;
judging whether the bidding for the tendered product was successfully closed or not; and
determining whether the auction should be terminated or a following tender for the products registered beforehand as products related to the product should be made according to the judgment of the bidding.

2. The method for automatically bidding for the item at the online auction in claim 1, wherein the priority level is set to two or more products registered in the above-mentioned product group setting table, in said determining step, if said bidding is successfully closed, the tender is ended, and if not successfully, tendering for the following product to which is set as a priority level higher next to said product.

3. The method for automatically bidding for the item at the online auction in claim 1, wherein the subordinate product associated with said successful closing bid is set to two or more products registered in the above-mentioned product group setting table, in said determining step, if said bidding is successfully closed, the tender is ended, and if not successfully, tendering for the another product which is set as the subordinate product of said successful closing bid.

4. A computer-readable recording medium recorded with automatically bidding program for an item placed on show at an online auction via a network using a computer, the program comprising the steps of:
tendering a bit for one of products by referring to a product group setting table in which a number of products are preliminarily registered and a predetermined relationship between those products is set up;
judging whether the bidding for the tendered product was successfully closed or not; and
determining whether the auction should be terminated or a following tender for the products registered beforehand as products related to the product should be made according to the judgment of the bidding.

5. A computer-readable recording medium recorded with automatically bidding program in claim 4 for an item placed on show at the online auction via network using computer, wherein the priority level is set to two or more products registered in the above-mentioned product group setting table, in said determining step, if said bidding is successfully closed, the tender is ended, and if not successfully, tendering for the following product which is set as a priority level high next to said product.

6. A computer-readable recording medium recorded with automatically bidding program in claim 4 for an item placed on show at the online auction via network using computer, wherein the subordinate product associated with said successful closing bid is set to two or more products registered in the above-mentioned product group setting table, in said determining step, if said bidding is successfully closed, the tender is ended, and if not successfully, tendering for the another product which is set as the subordinate product of said successful closing bid.

7. An apparatus for automatically bidding for an item placed on show at an online auction via a network using a computer, comprising:
a means for tendering a bit for one of products by referring to a product group setting table in which a number of products are preliminarily registered and a predetermined relationship between those products is set up;
a means for judging whether the bidding for the tendered product was successfully closed or not; and
a means for determining whether the auction should be terminated or a following tender for the products registered beforehand as products related to the product be made according to the judgment of the bidding.

8. An apparatus for automatically bidding for an item placed on show at the online auction via network using computer in claim 7, wherein the priority level is set to two or more products registered in the above-mentioned product group setting table, in said determining step, if said bidding is successfully closed, the tender is ended, and if not successfully, tendering for the product to which is set as a priority level high next to said product.

9. An apparatus for automatically bidding for an item placed on show at the online auction via network using computer in claim 7, wherein the subordinate product associated with said successful closing bid is set to two or more products registered in the above-mentioned product group setting table, in said determining means, if said bidding is successfully closed, the tender is ended, and if not successfully, tendering for the another product which is set as the subordinate product of said successful closing bid.

10. A method for automatically bidding for an item placed on show at an online auction via a network using a computer, comprising the steps of:
tendering a bit for one of products by referring to a product group setting table in which a number of products are preliminarily registered and a predetermined relationship between those products is set up as a group;
judging whether the bidding for the tendered product was successfully closed or not; and
determining whether the auction should be terminated or a following tender for the products registered beforehand as products related to the product be made according to the judgment of the bidding;
wherein if said bidding is successfully closed, it tenders for the product of the highest priority level in an another group which belongs to the subordinate group of said tendered product, and if not successful, for the product of the next priority level among another products which belong to group of said tendered product.
